(19) United States
(12) Patent Application Publication
(10) Pub. No.: US 2008/0318050 A1
(43) Pub. Date: Dec. 25, 2008

(54) Latent Heat Storage Material

(75) Inventor: Alois Baumann, Rain (DE)

Correspondence Address: LERNER GREENBERG STEMER LLP, P O BOX 2480, HOLLYWOOD, FL, 33022-2480, US

(73) Assignee: SGL CARBON AG, Wiesbaden (DE)

(21) Appl. No.: 12/144,291

(22) Filed: Jun. 23, 2008

(30) Foreign Application Priority Data
Jun. 22, 2007 (DE) 10 2007 029 273.4

(51) Int. Cl. B32B 37/10; B32B 9/00

(52) U.S. Cl. 428/408; 156/306.3; 156/268

(57) ABSTRACT

A latent heat storage material is formed of at least two plies of a compressible graphitic material in which graphite wafers are arranged substantially in layer planes lying one on the other and which is infiltrated with at least one phase change material. The surface of each ply being provided with a structuring reaching the outsides of the graphite material. The evacuation and infiltration travel lengths in the layer planes, due to the structuring, amounts to a maximum of 200 mm.

The invention relates to a latent heat storage material which consists of at least two plies of a compressible graphitic material and is infiltrated with at least one phase change material and to a method for producing such a latent heat storage material.

Latent heat storage materials based on graphitic materials which are mixed, impregnated or infiltrated with a phase change material are known from the documents DE 196 30073 and EP 1 598 406. The graphitic materials form a highly heat-conductive matrix for the substantially less heat-conductive phase change materials and therefore allow a better heat exchange of the latent heat storage materials thus obtained. In particular, for the production of simple moldings, the pressing of expanded graphite precompacted into boards is appropriate. Infiltration of moldings consisting of compacted expanded graphite is impeded by the low rate of penetration of phase change material. For such boards consisting of compacted expanded graphite, long process times for the evacuation and infiltration are necessary in order to avoid the situation where too little PCM is taken up. Disadvantageous here are long process times or a low storability of the latent heat storage material thus produced.

The set object of the invention is to specify a latent heat storage material which consists of at least two plies of a compressible graphitic material and is infiltrated with at least one phase change material. The set object of the invention, furthermore, is to provide a method for producing such a latent heat storage material.

The object is achieved by means of the characterizing features of patent claim 1. Advantageous refinements are presented in the further claims. The proposed structuring promotes the evacuation of the graphite matrix. As a result, the air included in the graphite matrix is removed more quickly and more completely and a faster infiltration of the graphite matrix and also a higher degree of filling with the phase change material are achieved.

The compressible graphite material used for improving the thermal conductivity of the latent heat storage material is produced in a way known per se by the thermal expansion of interstitial graphite compounds into what is known as expanded graphite and by the subsequent compression of the expanded graphite into flexible sheets or into boards (U.S. Pat. No. 3,404,061; DE 26 08 866; U.S. Pat. No. 4,091,083).

The compressible graphite plies may already have the bulk density which is intended for them in the finished latent heat storage material. The pressure force applied when the plies of compressible graphite are pressed together to produce the latent heat storage material shall then not exceed the compression pressure required for achieving the given bulk density of the compressible graphite ply. However, even initially compressible graphite plies with a lower bulk density from the final bulk density in the finish-pressed latent heat storage material may be applied. Only then is the intended final bulk density generated when the components of the latent heat storage material are pressed together.

The groove depth in the rough-pressed article should preferably amount to at least 3.5 mm. The pressing of the rough-pressed articles into bundles, first in height and then in bundle width, does not result in a homogeneous degree of pressing of the strips. The degree of cross-linking of the strips decreases in the pressing direction and opposite to the pressing direction leads to ever smaller groove depths.

Pressing should preferably take place in the order of bundle widths and then height. In this case, a height of 12.2+/−0.2 mm and a width of 30.7+/−0.2 mm of the rough-pressed articles, with grooves which are approximately 3.5 mm deep and approximately 4.5 mm wide, have proved to be advantageous. Preferably, 30-250 strips of the rough-pressed articles are pressed into a bundle.

The invention is explained below by way of example by means of examples of implementation.

### COMPARATIVE EXAMPLE 1

Strips with the dimensions (480 mm length, 40 mm width, 15 mm thickness) are pressed into a bundle.

The bundle weight of compacted graphite amounted to 862 g. Such a bundle is introduced into a bag and is evacuated with the aid of a vacuum pump up to a pressure of 10 mbar. The evacuation time amounted to 220 s.

Infiltration with 3100 ml of water as phase change material subsequently took place. After storage for approximately six hours, approximately 300-400 ml of free water was still found.

### COMPARATIVE EXAMPLE 2

In a similar way to example 1, a lighter bundle was assembled and pressed together. The bundle weight of graphite amounted to 770 g.

After an evacuation time of 220 s, infiltration with 3100 ml of water took place.

Deformation of the bag (bladder) very high. Sensor inoperative. Filling operation is concluded.

Still a large amount of free water.

After storage for approximately six hours, still approximately 500-600 ml of free water.

### COMPARATIVE EXAMPLE 3

In a similar way to example 1, a bundle was assembled and pressed together. The bundle weight of graphite amounted to 757 g.

The evacuation time was increased to 500 seconds.

The filling operation takes place approximately normally. Deformation of the bag slightly greater. Bundle firm after storage for 10 minutes.

### EXAMPLE 1

Approximately 15 diagonal grooves were introduced by hand on each of the two sides at an angle of approximately 45°.

| | |
|---|---|
| Bundle weight of graphite: | 775 g |
| Evacuation time: | 500 s |

The filling operation proceeds normally. Deformation of the bag normal. Bundle immediately firm.

### EXAMPLE 2

Before pressing, 2 longitudinal grooves and 4 diagonal grooves are introduced on one side.

| | |
|---|---|
| Bundle weight of graphite: | 806 g |
| Evacuation time: | 220 s |

Observations: filling operation proceeds normally. Deformation of the bag normal. Bundle firm in the machine.

### EXAMPLE 3

2 longitudinal grooves are introduced on one side by hand in series strips, evacuation time is fixed at 90 seconds:

| | |
|---|---|
| Bundle weight of graphite: | 780 g |
| Evacuation time: | 90 s |

The filling operation proceeds normally. Deformation of the bag normal. Bundle firm after storage of 10 minutes.

The results of further examples are illustrated in summary in Table 1.

| | | | Groove | Bundle weight | | | Result | |
|---|---|---|---|---|---|---|---|---|
| | Strip | | before | After | After | Evacuation | After | After |
| Example | Width | Height | pressing | pressing | filling | time | 10 s | 600 s |
| 11 | 11.8 | 41/40.1 | 3 | | | 90 sec. | free | |
| | | | | | | | water | |
| 12 | 11.8 | 41/40.1 | 3 | | | 90 sec. | free | firm |
| | | | | | | | water | |
| 13 | 11.8 | 41/40.3 | 3.5 | 579 | 3698 | 90 sec. | free | firm |
| | | | | | | | water | |
| 14 | 11.8 | 41/40.1 | 3.5 | 574 | 3449 | 90 sec. | free | firm |
| | | | | | | | water | |
| 15 | 10.7 | 41/40.5 | 3.5 | 582 | 3696 | 90 sec. | free | firm |
| | | | | | | | water | |
| 16 | 10.7 | 41/40.3 | 3 | 573 | 3739 | 90 sec. | free | firm |
| | | | | | | | water | |
| 17 | 10.7 | 41/40.4 | 3.5 | 571 | 3717 | 90 sec. | free | firm |
| | | | | | | | water | |
| 18 | 10.7 | 41/40.3 | 3.5 | 580 | 3678 | 90 sec. | free | firm |
| | | | | | | | water | |
| 19 | 10.7 | 41/40.4 | 3.5 | 578 | 3706 | 90 sec. | free | firm |
| | | | | | | | water | |

1-10. (canceled)

11. A latent heat storage material, comprising:
at least two plies of a compressible graphitic material with graphite platelets disposed substantially in layer planes lying one above the other and infiltrated with at least one phase change material;
each ply having a surface formed with a surface structuring reaching the outsides of said graphite material and defining evacuation and infiltration travel paths; and
a travel length of said evacuation and infiltration travel paths in said layer planes due to said structuring amounting to a maximum of 200 mm.

12. The latent heat storage material according to claim 11, wherein said travel lengths of said evacuation and infiltration travel paths in the layer planes due to the structuring amount to a maximum of 50 mm.

13. The latent heat storage material according to claim 11, wherein said structuring is in the form of channels having a ratio of a depth to a width in a range of 20:1 to 1:20.

14. The latent heat storage material according to claim 13, wherein said channels are arranged parallel to said graphite layers.

15. The latent heat storage material according to claim 13, wherein said channels are arranged in a configuration selected from the group consisting of a rectilinear configuration, a meander-shaped configuration, or a herringbone shape configuration.

16. The latent heat storage material according to claim 11, wherein said channels extend in an evacuation and/or infiltration direction.

17. A latent heat storage material, comprising:
a bundle formed of two or more plies of a compressible graphitic material with graphite wafers disposed in layer planes lying one above the other, said bundle having an exterior and an interior;
said plies having surfaces formed with structuring defining evacuation and infiltration paths extending from the interior to the exterior of said bundle, a travel length of said evacuation and infiltration paths in the layer planes amounting to no more than 200 mm; and
an amount of phase change material infiltrated in said compressible graphitic material.

18. A method of producing a latent heat storage material, which comprises:
providing a plurality of plies of a compressible graphitic material, and providing up to 30% of a surface of each ply with a structuring reaching the outsides of the material;
bringing two or more plies of the compressible graphitic material into contact with one another, and pressing the plies formed with the structuring at a temperature of up to 400° C. and at a pressure of between 0.1 MPa and 200 MPa.

19. The method according to claim 18, which comprises evacuating the graphite material and infiltrating the layer material with phase change material in one direction or from one side.

20. The method according to claim 18, which comprises pressing or rolling channels into the plies of compressible material, the channels having a cross section with sharp edges.

21. The method according to claim 18, which comprises milling channels into the material.
